(19) United States
(12) Patent Application Publication
(10) Pub. No.: US 2014/0372160 A1
(43) Pub. Date: Dec. 18, 2014

(54) CONTEXT-AWARE MOBILE CROWDSOURCING

(71) Applicant: Microsoft Corporation, Redmond, WA (US)

(72) Inventors: Suman K. Nath, Redmond, WA (US); Jie Liu, Medina, WA (US); Michel Goraczko, Seattle, WA (US); Dimitrios Lymberopoulos, Bellevue, WA (US); Aman Kansal, Redmond, WA (US)

(21) Appl. No.: 13/918,865

(22) Filed: Jun. 14, 2013

(51) Int. Cl. G06Q 10/06

(52) U.S. Cl. CPC G06Q 10/06311
USPC 705/7.13

(57) ABSTRACT

The subject disclosure is directed towards a context-aware mobile crowd sourcing service/system. Context information is automatically collected for a mobile device via mobile-device sensors. When a task is received that specifies context-related criteria, a worker is selected for that task based at least in part upon the context information associated with that worker's mobile device. Sensors on the device may be leveraged to capture information related to performing the task. Also described is a cross-platform task configuration that allows a task to be written once and run on different mobile device platforms.

### BACKGROUND

Crowdsourcing generally refers to solving tasks via a large scale community (the “crowd”), relying on people who work remotely and independently via the Internet. Crowdsourcing is based upon the idea that large numbers of individuals often act more effectively and accurately than even the best individual (e.g., an “expert”).

As mobile devices, such as smart phones and tablets, become popular (and in some places prevalent) computing platforms, a trend is moving towards tasking people in the physical environment to perform crowd sourcing jobs. However, existing mobile crowdsourcing systems are limited and do not take advantage of users' mobility.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, one or more of various aspects of the subject matter described herein are directed towards maintaining context information based upon sensor data received from mobile device clients corresponding to workers. Upon receiving a task set comprising one or more tasks for which a worker set comprising one or more workers is needed to perform, task metadata associated with the task is accessed, in which the task metadata specifies one or more context-related criteria. The context information is accessed to select one or more workers for the worker set based at least in part upon matching the context information of each selected worker with the one or more context-related criteria of the task metadata. The task set is assigned to the worker set.

In one or more aspects, a mobile crowd sourcing service assigns tasks to mobile workers. The service includes a task server configured to receive tasks from a task issuer, and a task broker configured to match received tasks with selected workers corresponding to mobile device clients. The task broker matches one or more workers to a task based upon per-worker data and one or more worker-related task criteria associated with the task, and based upon per-worker context information and one or more context-related task criteria associated with the task.

One or more aspects are directed towards providing an application for executing on a mobile device, in which the application executes a crowdsourcing task selected for a user of the mobile device based at least in part upon context information sensed at the mobile device. The application may use at least one sensor of the mobile device to automatically perform at least part of the task. The application may execute at least one task written as a cross-platform task.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing a general overview of a context-aware mobile crowdsourcing service for coupling task issuers with mobile device client workers, according to one or more example implementations.

FIG. 2 is a block diagram representation of components of a context-aware mobile crowdsourcing service, according to one or more example implementations.

FIG. 3 is a representation of various input data including current context that is used by a task broker to match tasks to workers, according to one or more example implementations.

FIG. 4 is a flow diagram representing example steps that may be taken to select one or more workers for a task, according to one or more example implementations.

FIG. 5 is a flow diagram representing example steps that may be taken to assign a task to a worker and manage task completion, according to one or more example implementations.

FIG. 6 is a block diagram representing example non-limiting networked environments in which various embodiments described herein can be implemented.

FIG. 7 is a block diagram representing an exemplary non-limiting computing system or operating environment, in the form of a mobile device system, into which one or more aspects of various embodiments described herein can be implemented.

### DETAILED DESCRIPTION

Various aspects of the technology described herein are generally directed towards using mobile crowdsourcing in a way that leverages workers' current context, such as their current location, current state and other conditions. This facilitates context-aware distribution of tasks to workers.

In one or more aspects, a context aware mobile crowdsourcing system is provided that allows cross-platform mobile crowd sourcing tasks to be sent to users. In this way, regardless of the operating system/platform of any user's mobile device (at least for most popular platforms and devices), that user is able to receive a task.

In one or more aspects, part of a user's context may be automatically collected from a mobile device's sensors. Users thus may be tasked based on their context, such as location, motion, background noise (current audio state), companion, mood, and so on, in addition to worker-related data such as their availability, abilities, past performance and reputation. In this way, an intelligent decision may be made on selecting candidate workers for a task, whereby a more relevant, higher quality and/or more informed task resolution (e.g., answer) may be obtained (as opposed to hiring workers randomly). Device-embedded sensors, such as a location sensor, camera, and microphone also allow workers to capture objective data (e.g., reality) in addition to or instead of making only subjective judgments.

As another advantage, because people carry mobile devices with them, it is easier for workers to more spontaneously perform crowd sourcing jobs, e.g., just “kill time” when otherwise idle. As a result, the cost of a task to the task issuer may be lower and/or the return time of finishing a set of tasks can be faster. Further, because such devices are personalized with authentication, and sensors may help confirm identity, it is easier to link the same person across devices to prevent fraud, such as multiple people sharing an account to maximize rewards.

It should be understood that any of the examples herein are non-limiting. For example, while some of the examples herein are for mobile devices, some of the concepts may be applied to non-mobile devices. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in mobile devices and crowdsourcing in general.

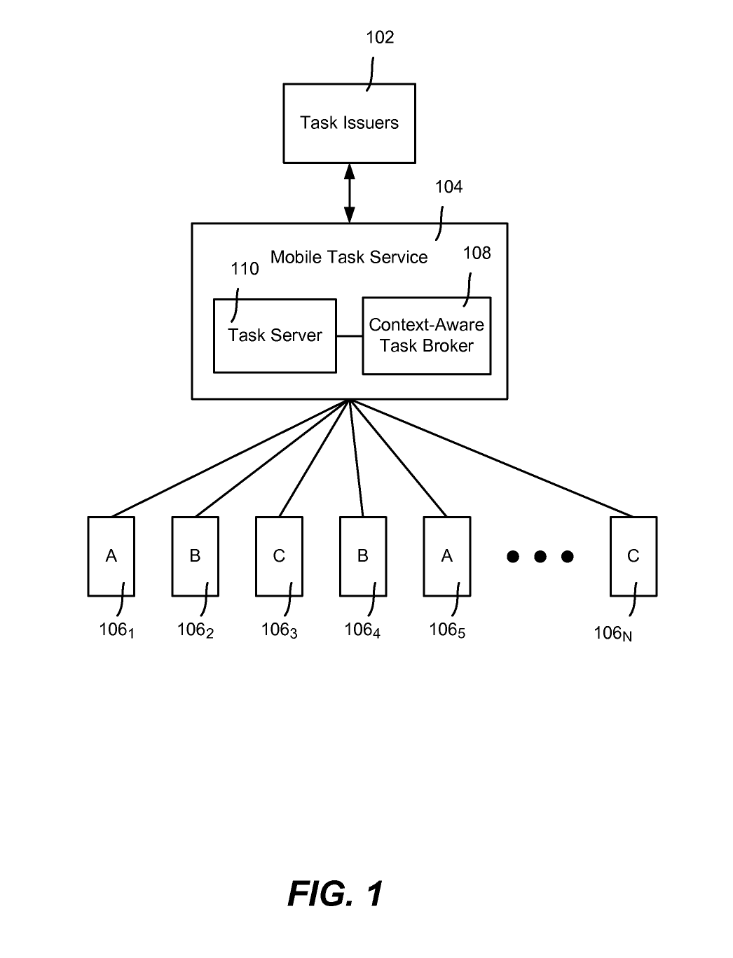

FIG. 1 is a general conceptual diagram showing how task issuers 102 interact with a mobile task service 104 to provide tasks (jobs) to a plurality of mobile workers via worker devices 106₁-106_{N}. In general, the workers perform tasks and return results to the mobile task server, typically in exchange for some compensation. In general, as used herein the terms “job,” “task” and “subtask” (part of a larger task) are synonymous, unless otherwise noted.

As described herein, workers may be selected for a task based (at least in part) on their current contexts. To this end, a context-aware task broker 108 considers any number of criteria in selecting candidate workers to offer one or more of them a task. If an offer is made and a task accepted, a task server 110 takes over the task and assigns the task to the worker (or more than one worker), and tracks completion status.

Depending on the type of task, the workers may update the task server 110 and/or task issuer 102 with data as to the state of partial completion of a task, which may be an obligation for a given task. For example, some tasks may require coordination, timing and so forth between multiple workers to accomplish different subtasks of a larger task, whereby a certain state of a first worker with respect to his or her partial completion of a subtask may trigger the start of another subtask to be performed by a second worker. In such an event, part of the first worker's subtask may be to provide state information to the task server, (e.g., eighty percent completion point reached), whereby the task server 110 or task broker 108 can instruct the second worker to start the other subtask.

When a task (including a subtask) is complete, the worker provides results to the task issuer 102, e.g., directly or via the task server 110. For example, the task server 110 may verify the results before closing the task and sending the results or some corresponding data (e.g., a compilation of the results of many workers) to the task issuer 102.

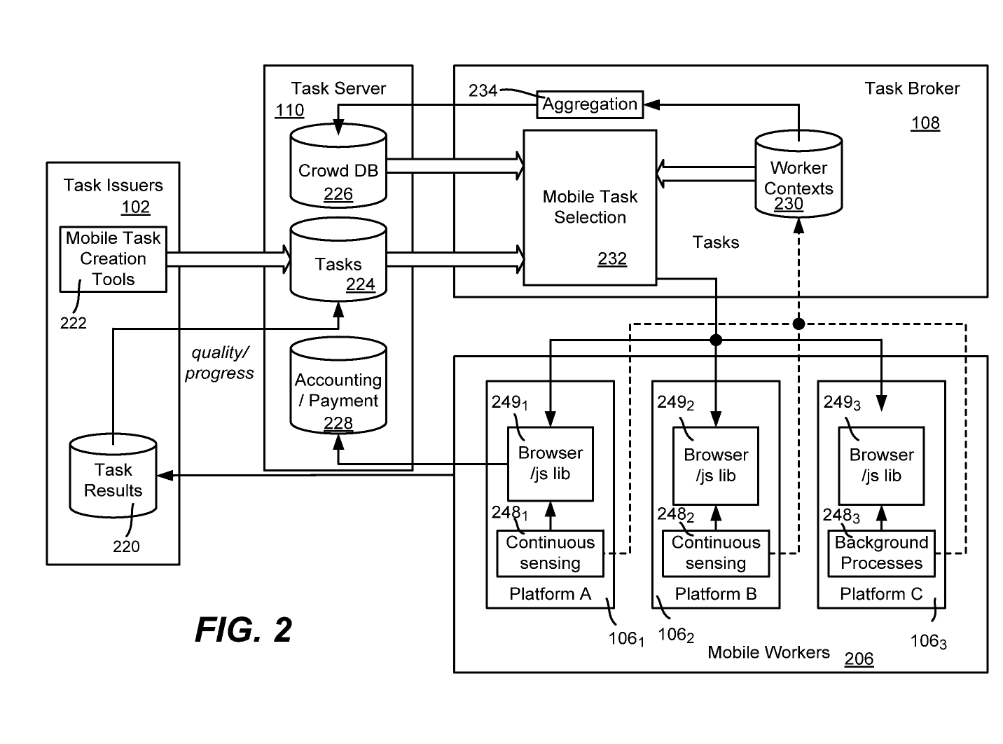

FIG. 2 shows example components of one suitable architecture, which is generally arranged in the roles corresponding to FIG. 1, e.g., task issuers 102, a task server 110, a task broker 108, and mobile workers 206 (corresponding to the devices 106₁-106_{N} of FIG. 1). In general, the task issuers 102 create tasks to be sent to mobile workers 206 and collect the results, e.g., in a results database 220 (e.g., one such database is maintained per task issuing entity).

In one implementation, mobile tasks may be written via creation tools 222 once, in a way so as to be cross-platform (among the various mobile device platforms in use, or at least the most popular ones) in order to reach a large population of potential workers without needing to implement each task in a different per-platform version. It is feasible to write tasks for different platforms, or convert a task into different versions via some intermediary conversion components, but as can be readily appreciated this generally not as desirable as having tasks written in a cross-platform way without considering the destination platform.

For example, one way this may be accomplished is by using TouchDevelop (www.touchdevelop.com) technology including TouchDevelop script/task creation tools, which provides a suitable cross-platform development environment. TouchDevelop scripts are transmitted in text form and may be compiled into html/JavaScript on a destination device. Using the touch develop language allows tasks to be simplified via straightforward user interface concepts, while hiding JavaScript complexity (e.g., error handling) from the task writer. The TouchDevelop technology allows the publication of the task directly onto the TouchDevelop website, providing access to tasks by the task server 110. Further, as described below, with respect to sensors/sensing, TouchDevelop also provides a unified sensor API to JavaScript via a Touch Develop compiler, which makes the tasks involving sensors also portable across platforms.

Touch Develop also allows the creation of individual scripts for “one-of-a-kind” tasks or libraries that may be used as templates for bulk tasks. Thus, the task issuers 102 are able to create libraries (or templates) for tasks. Each task may be composed of multiple steps (e.g., subtasks), each allowing to collect an answer (step result) under the form or text or richer data.

Notwithstanding, other task creation platforms are feasible, and Touch Develop is only an example of a suitable one.

As shown in FIG. 2, the task server 110 receives tasks from the task issuers 102. Tasks may be associated with metadata to give hints on what kind of worker is targeted, for example. The expressiveness of the metadata, and its mapping to worker demographic and context information, may be in any suitable format.

By way of example, consider that a task is directed to collecting speech data for speech recognition training purpose. The application may want to address a particular demographic such as people who have Spanish as first language and English as a second language. The task is to give the worker a paragraph in English, to ask the worker to read it loud and to record the audio to a file. The task needs to be performed in a relatively quiet environment, preferably when the worker is at home. The following information may be specified with the task via metadata:

Task: Collect up to thirty seconds of audio based on a short text.
Qualification:
   Quiet surrounding environment
   Language spoken (native language, secondary language)
   Wi-Fi presence or availability for inexpensive data uploads
   Age group
Rules:
   Background noise discrimination
   Completeness of the text to read

In one implementation, the task server 110 is configured as a centralized server to stage tasks 224, maintain worker accounts (crowd DB 226), and maintain accounting/payment information 228. The task server 110 may act as a centralized index for other participants to coordinate tasks, workers, and transactions. Note that payment may be actual money, points that may be exchanged for goods and/or services, gaming points that have value to game players, and/or other rewards. Notwithstanding, some tasks may be done by volunteers without compensation.

In one implementation, the service 104 leverages an existing task management system (e.g., UHRS—Universal Human Relevance Platform). The UHRS system, built for conventional (non-mobile) crowdsourcing has user management, task source, and accounting functionality that may be adapted for mobile crowdsourcing in a straightforward way.

The task broker 108 automatically performs worker-to-task matching using the metadata specified by the tasks as well as static and real-time information about the workers. A general goal is to maximize the quality of results (e.g., answers) while remaining within a task issuers' budget constraints. To make this happen, the task broker 108 extracts workers' contextual information 230, e.g., continuously or opportunistically.

The task broker 108 loads tasks from the task server 110 (there may be multiple task servers) and organizes the tasks by locale, time, current progress (how many answers it has already received), and other properties. The task broker 108 loads or queries for workers' static information from the task server 110 to extract properties such as demographics, familiar places, accessibility to transportation (e.g., own a car, take public transit), topics of expertise, cost, availability times, past reputation and so on.

Context may be extracted via the help of contextual sensing on workers' mobile devices. For example, the task broker 108 may keep track of the real-time contextual information 230 about each worker to the extent available (and consented to), such as current locations and trajectories, places (e.g. home, work, coffee shop, and so on), surroundings (e.g. alone, with people, in noisy environment, and so on), schedule (e.g. idle, have meeting in ten minutes, on the way to dinner party, and so on), and/or the like.

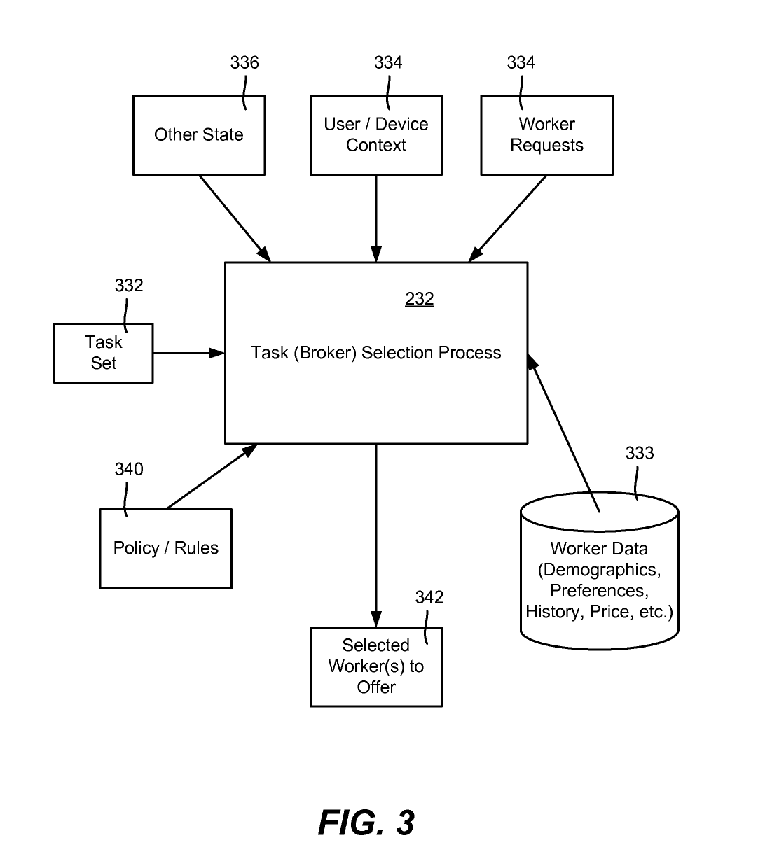

FIG. 3 exemplifies some of these concepts, in which a task selection process 232 of the task broker 108 takes various information and computes the likelihood for a given worker to perform a given instance of a task at a given price at the moment, and what is the expected quality of the result or results. Based on these metrics, the task selection process 232 selects the highest ranked worker to offer the task.

In FIG. 3, example inputs to the task selection process 232 include the task set 330 (one or more tasks to be performed), queried user data 333 for a plurality of workers, including data indicating demographics (e.g., age, gender), per-worker preferences (availability data indicates does not work after 10 pm), history (e.g., reputation), cost and/or other qualification data (e.g., some workers may be classified as an expert in a certain area and charge more, and a task may specify the need for an expert), and so on. This is static (or relatively static) data related to each worker. Note that the real-time context data may be aggregated (block 234, FIG. 2) to update the static information about the worker in the task server 110.

The user and device context 334 may be gleaned from device sensors, for example. Thus, it may be inferred from GPS data or the like where the user is and what trajectory the user is on, whether the user is in a quite environment, and so on. Virtually any device sensor may provide such information by pushing it to the task broker 108 or in response to a task broker request, provided the device is capable of doing so and the user consents to providing this information, which may be on a per-sensor basis (e.g., location data yes, microphone/noise level data no).

As set forth above, the selection process 232 also needs to know the current (other) state 336, e.g., time-of-day, day-of-week and so on to match user preferences such as availability to perform a task at a given time/date. Some tasks may be weather-dependent, e.g., capture a photograph at location X on a sunny day, whereby weather information at location X is another example of current state 336 that may be considered.

User requests 338 are another consideration. For example, a worker may proactively request work, such as when that worker is generally idle, regardless of whether the context indicates that the worker is idle. For example, a worker may be doing something to pass the time that via the sensor data indicates the worker is busy/not available, but the worker may gladly stop that activity to perform a task.

Yet another input to the task selection process 232 may be policy/rules 340. For example, laws or regulations may exist that need to be complied with before hiring a worker for a task. For example, if a regulation indicates that a child under sixteen can perform no more than ten hours of tasks per week, then a child who has reached the limit is not to be selected, even though the task may not specify an age or specifically request someone under sixteen. As laws and regulations change regularly, the task selection process 232 may need to access such data.

As can be readily appreciated, other input to the task selection process 232 may be needed or may be desirable to have in various decision making situations. Thus, the inputs in FIG. 3 are only non-limiting examples.

The output from the task selection process 232 is a set of one or more selected workers 342 that meet the criteria or criterion in the task set 332. The worker or workers may be selected from a set of candidate workers, such as candidates ranked according to a score, for example, e.g., based on the highest qualified available person at the lowest rate, and so on. Note that if the set of workers is empty or does not contain enough workers, that is, no qualified worker or not enough qualified workers can be matched to a task, (e.g., a task specifies an expert but the specified budget does not allow for an expert to be hired), the task may be rejected. For purposes of description hereinafter, the examples are directed towards situations in which the needed number of one or more workers exists.

With the list of candidates, the task broker 108/selection process 232 may select them, such as by the accompanying ranking score. The task broker 108 may then proactively “push” an offer to the selected mobile device user, or attempt to match the task to a worker who has requested work, to ask whether the worker will accept the task. Whether the task broker 108 pushes a task may be dependent on the score associated with that worker, e.g., which may be a confidence score or the like corresponding to that worker's ability to complete the task with an acceptable quality result. The confidence score or the like may correspond to factors such as that worker's ability to complete the task with an acceptable quality result, the availability of the worker to engage in the task now or in the near future (e.g., based on context such as the worker being busy in a meeting), and/or the predicted movement of the worker that indicates that the worker is likely to move into the context required to finish the task.

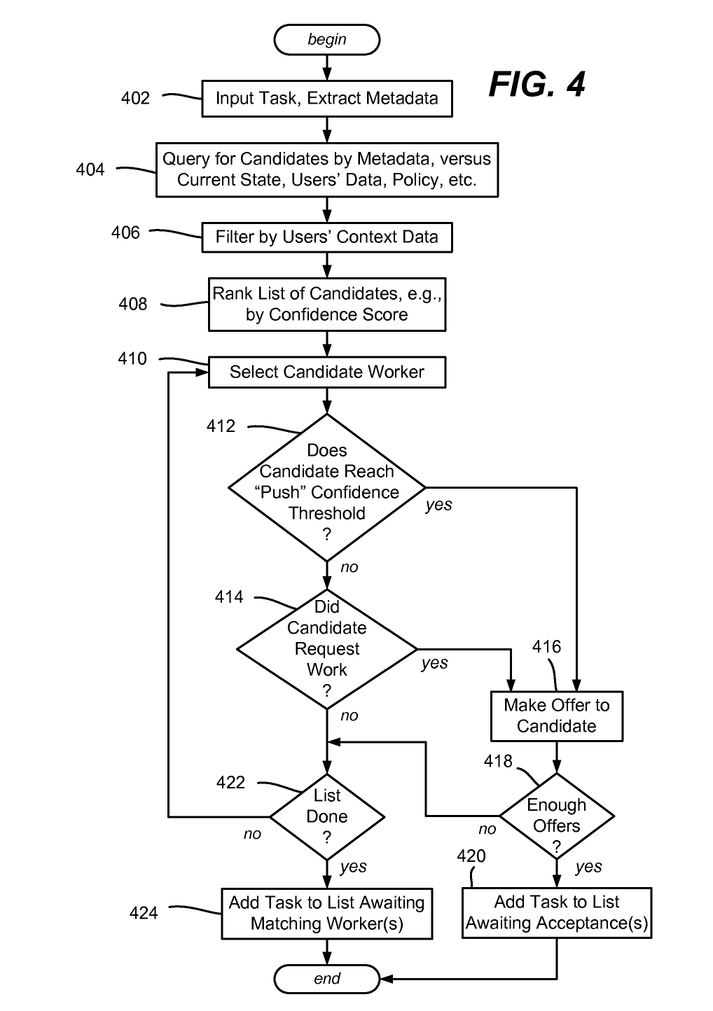

FIG. 4 summarizes some of the above concepts, beginning at step 402 where a task is input into the task broker 108, and the task broker 108 extracts the metadata therefrom. Based upon the metadata, at step 404 the task broker obtains a candidate list of matching candidates, who may be accompanied by a confidence or other similar score, or data by which such a score may be computed. Note that step 404 represents this as a query to the worker crowd database 226, for example, however it is understood that multiple such queries may be used, and/or bulk requests for workers may be made, with filtering performed by the task broker 108, and so on. In general step 404 represents using the static or relatively static data to narrow down the worker pool in a first operation.

Step 406 represents filtering the list further based upon the context data that is known for each user. For example, the task may want the address of a business in San Diego verified within the next twenty minutes. Thus, although the query at step 406 may have specified that only workers having an address in the San Diego area (e.g., via certain zip codes) be returned as candidates to the task broker, this is not sufficient for the task. Instead, among the returned pool of candidate workers, only workers able to get to the business address within the time limit, as determined via the candidates' context data, are sensible as workers to whom an offer may be extended. In general step 406 represents using the dynamic data to narrow down the worker pool in a second operation.

Step 408 represents ranking the workers using any suitable ranking algorithm; (note that the workers may have been ranked or associated with a score from the original query, however ranking/scoring may change due to context). For example, the various worker data and current context data may be considered weighted features that each contribute to a total score for each worker.

Step 410 starts processing the list of remaining workers. As mentioned above, offers may be delivered by a (e.g., push) notification if a computed confidence level is reached (step 412) or in response to worker queries (step 414). Thus, if the currently selected worker meets the criterion at step 412 or the criterion at step 414, an offer is made at step 416.

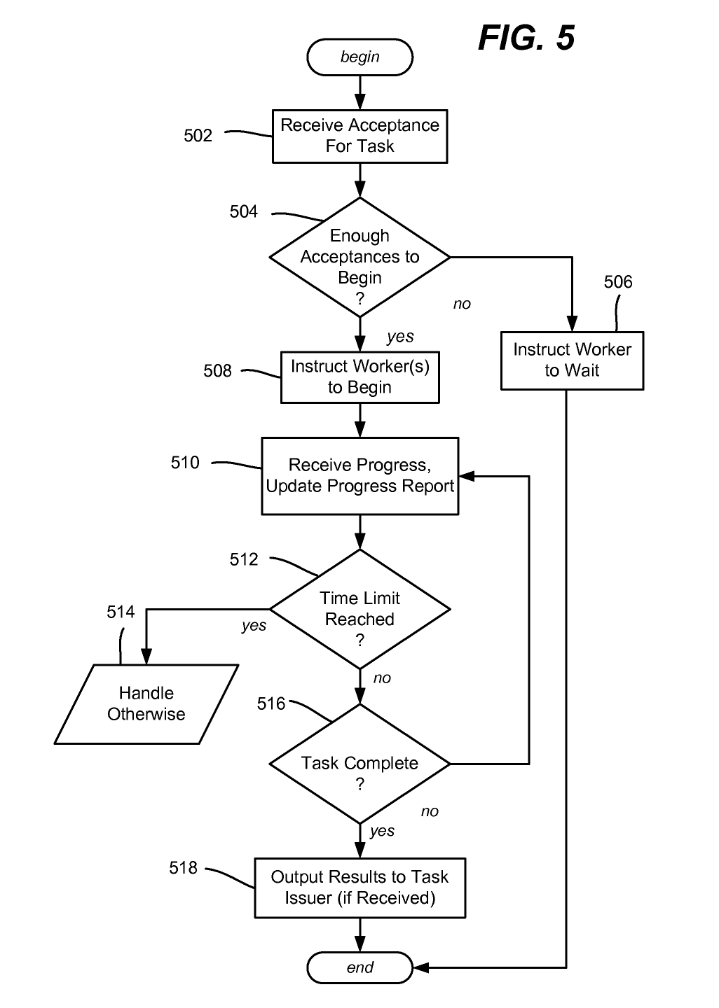

As part of the offer, the worker may be given a set of one or more tasks with corresponding price ranked by the expected result quality per unit cost, a time limit, and so on. The worker may then accept the offer (FIG. 5) or reject the offer. The offer may time out if the worker does not accept within a specified time.

Step 418 represents evaluating whether enough offers have been made. For example, a task may specify that three workers are desired, whereby three offers at a time may be outstanding. If an acceptance comes in while the list is still being processed to extend offers, then the outstanding number allowed by step 418 is decremented. When the number of offers has been extended, the task is added (step 420) to a list of tasks having outstanding offers awaiting acceptance.

Step 422 repeats the process until enough offers have been made (step 420) or the candidate list is exhausted. If exhausted, step 424 adds the task to a list awaiting at least one matching worker. At any time the task issuer may be updated with respect to the status of a task, e.g., workers offered pending acceptance, not enough workers available, and so on.

As can be readily appreciated, the steps exemplified in FIG. 4 may be re-run as appropriate for a given task set. For example, if an outstanding offer is turned down, then a new offer needs to be extended, which may be on demand in response to the rejection. If not enough workers are found for a task, then a new list may be regenerated (e.g., periodically) to see if more have become available at a later time, for example. If workers cannot be found, the task broker may update the task issuer as appropriate, e.g., very quickly for a time-sensitive task set, or on some less frequency schedule for one that is not time sensitive.

FIG. 5 represents example task assignment concepts, once an acceptance is received at step 502. If there are enough other acceptances for the accepting worker to begin, then the worker is instructed to begin (step 504); for many tasks the single worker acceptance is the only acceptance that is needed. Otherwise the worker is asked to wait (step 506), with the acceptance logged for checking a total as other offers for this task get accepted. Although not shown, the worker may reject an offer if he or she is asked to wait, unless the possibility of having to wait was agreed to as part of the acceptance. Note further that a worker may be asked to wait if the task start is contingent on another task reaching some completion level, as described above.

Step 508 instructs the worker or workers to begin the task, or at least a first part thereof. Note that the steps of FIG. 4 may be carried out by the task broker 108, whereas those of FIG. 5 may be carried out by the task server 110. However, this is only one possible implementation, and other implementations may be used; (for example, responsibility for a task may move from the task broker to the task server only when the worker or workers have accepted and at least a first part of the task is ready to start, e.g., at or after step 508).

Step 510 represents receiving progress data on the task, and updating a progress report or the like. This step may not be performed for all tasks, and indeed, is likely needed only for long-running tasks or tasks in which there is some dependency relationship with another task.

Step 512 applies to tasks having a specified time limit, and evaluates whether the time has been reached before the task is complete. If so, the block labeled 514 (“Handle Otherwise”) is performed. For example, depending on the task (e.g., as specified in metadata), the task may be reassigned to a new worker such as via the steps of FIG. 4. If instead the task issuer wants to be notified, e.g., because the task is no longer appropriate to perform once the deadline was reached, the issuer may be notified of the time limit expiration. Issuers of time-sensitive tasks need to account for this possibility, since they are dealing with possibly unreliable workers. Note that the reputation or other history data associated with the worker or workers may be adjusted to reflect the failure.

Step 516 represents determining whether the task is complete. If not, the process continues to wait until completed or a time limit is reached (step 512) waits for completion. When complete, (if the results are received at the task server, e.g., for some pre-processing with other results), the results are output to the task issuer at step 518, although alternatively the results may be directly sent from the mobile device to the task issuer, e.g., via the task server.

Turning to the mobile devices, as shown in FIG. 2 a mobile device (e.g., 106₁) of a worker runs a client application that is customized for the specific platform. In one implementation, the application includes a continuous context sensing component (e.g., 248₁), and a browser component (e.g., 249₁). Subject to the policies and capabilities of different operating systems, the continuous sensing component 248₁ on the device collects contextual information once the application is installed. For some platforms, context sensing/uploading can be run as background process, which can be aggressive and be invoked often. For other platforms, the background processes are more restricted. Instead, sensor data is collected only when the application is launched/running in the foreground, whereby contextual data may be collected only sporadically. As can be readily appreciated, as the popularity of mobile crowdsourcing grows, such more restrictive platforms may adapt to allow background context sensing.

In one implementation, the browser component 249₁ hosts the actual tasks. In addition to the default HTML/JavaScript capabilities of rendering documents in the user interface, the exposed sensor library (via TouchDevelop) allows tasks to collect and operate on sensor data.

In addition to the user interface, the script dynamically loaded with the task also may perform on-device data fidelity checking and fraud detection. For example, if recording a segment of people, speech is expected, whereby the task can perform sound analysis on the microphone input to ensure a good signal-to-noise ratio. If the quality criterion is not met, it can prompt the worker to redo the recording in real time, rather than looping back after the task results are checked. In this way, the crowd sourcing tasks broker is able to use sensors on the devices, as part of the answers, to verify data quality locally, or to detect and filter out frauds. Quality and fraud checking can leverage other cloud services as well.

A task result and/or step results may be submitted individually or as a group. As shown in FIG. 2, the task results database 220 may be used to store results from mobile workers, e.g., including symbolic (selection), numeric, and text inputs by workers, as well as rich data types such as pictures, videos, audios, and other sensors. From there, judgment (e.g., quality acceptable) and/or other results can be submitted to the task server 110 from the task issuer 102, possibly via a staging server or the like where richer data can be evaluated and a result can be supplied therefrom. Note that the task results database 220 is represented as being updated by the mobile workers and maintained by the task issuers, however it is understood that results may be sent to the task server or the like for pre-processing in some way and/or for accounting purposes.

By way of another practical example, business physical metadata (BPM) comprise properties that describe a business, which can help local search users decide whether to visit the business. These are in contrast to user reviews that are created by human input. Examples of BPM include address, location, store front pictures, crowdedness (at a particular time), noisiness (at a particular time), music at play (at a particular time), music volume (at a particular time), menu, friendliness to dietary restrictions and so on. Crowd sourcing is one way to fill in any gaps and/or validate existing information in the system.

Further, it is significant to have updated data in the database and good precision/correctness of the data. For example, often an address location is very general and does not pinpoint a location of a business, but rather the location of a complex or a mall. In a mobile version augmented with sensor data, a worker may simple use current location data. At the same time, the task may be suggested to other users passing in the vicinity of the area of the business.

The following metadata may be included as part of such as task:

Tasks: Verify location of existing business.
Qualifications (context information):
   nearby location to the business
Rules:
Same task can send up to three or more workers depending if the result matches up before then.

As described above, when creating task, via task metadata the task issuer can specify the preference on what kind of workers and under what criteria are needed for performing the task. The predicates can be built using demographical, statistical, or contextual information. Some of the information may be optional for users to supply (which may result in being selected less), and some verification may need to be provided by users (e.g., a user cannot simply profess to being an expert; verification testing may be a prerequisite).

The following sets forth some non-limiting examples of what may be considered and specified in metadata:
Task data usage indicates how much data is expected to communicate between the worker and the back end. Large data quantity may be an issue for workers with limited 3G data capacity (and possibly service providers) when there is no Wi-Fi connection.
Demographic and personal information—this information is based on user input when the user creates an account:
   Gender
   Age
   Ethnic group
   Home address
   Work address
   Native language
   Second language
   Home ownership
   Household size
   Household income
   Job functions
   Highest education level
   Favorite (sports, food, books, movies, etc.)
   Devices owned
   Data usage constraints (limited vs. unlimited data plans)
   . . .
Statistical (persona) information—these may be aggregated from past performance in the system, as well as inferred from real-time contextual data:
   Familiar neighborhoods
   Familiar businesses (business types)
   Familiar events (event types)
   Daily commute distances/duration
   Time spent at home/work/leisure
   Time spent indoor/outdoor
   Time spent at home town/travel
   Time spent on devices
   Physical activeness
   Social activeness
   Task performance statistics (responsiveness, minute rate, average quality, task frequency)
   . . .
Real-time context information—these are sent by the mobile device to the task broker after the worker launch the application (or via background sensing and uploading):
   Physical location
   Place (home/work/shopping/bus stop/gym/ . . . )
   In town/out of town
   Background noise level
   In-conversation/meeting
   Background music type/volume
   Transportation mode (walking/sitting/standing/bus/car . . . )
   Next appoint on calendar
   Current device type
   . . .

As described above, mobile tasks can go beyond question and answer collection, by leveraging the sensors on the devices to infer information based on sensor and worker input; for example:
Locations
Network connection (3G, Wi-Fi, etc.)
Microphone recording
Video/still image capture
Picture taking
Taking an action
Motion sensors—accelerometer, compass, gyro, etc.
Where/how the worker touches the screen (device interaction data).
. . .

The tasks can specify location filters and preliminary quality checking on these sensor data to ensure data quality.

Note that classifiers may be trained to convert raw sensor data to logical values (such as “at home” or “at work”). Training of such classifiers is done in the cloud, as they may require large amount of data across workers and significant computation. However, once trained, some classifiers can be deployed to the client application to prevent large data transfer in real time. Such classifiers can be building blocks for tasks to implement fraud detection and fidelity filtering.

As can be seen, there is described a mobile task management system/service designed to reaching correct workers at the correct moment and in the correct place. The task management system/service accomplishes this via people's context, such as location, background noise, companion (who is with them), and motion, to select the best available people to offer specific tasks. The mobile crowd sourcing task management system/service described herein achieves this via mobile context sensing. Further, a cross-platform task language makes task generation simple and makes sensors on mobile devices accessible to JavaScript.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

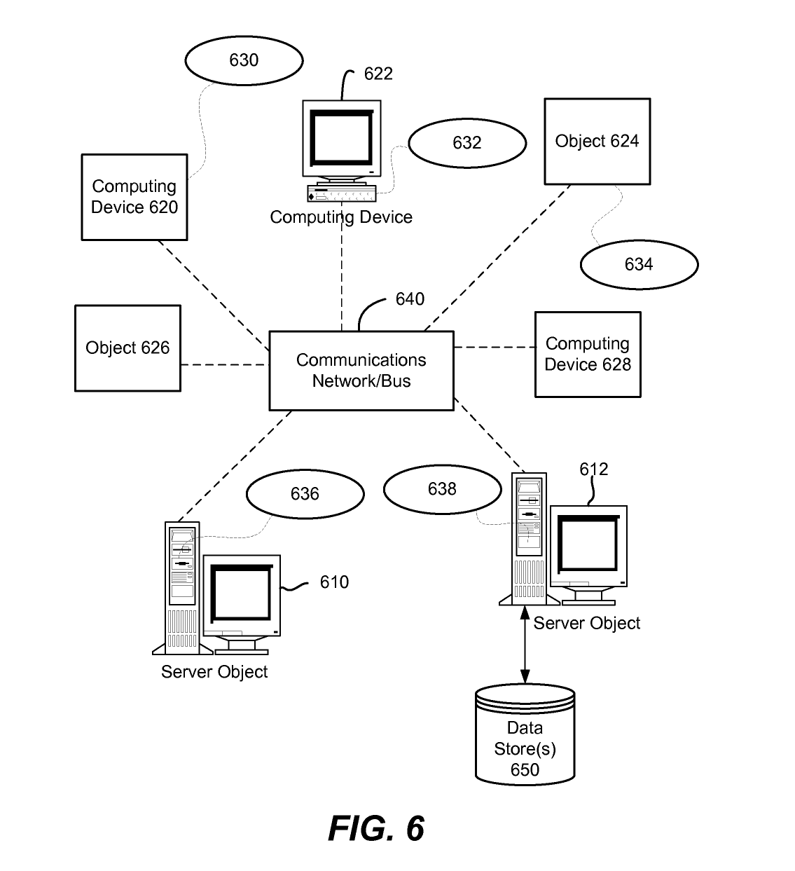

FIG. 6 provides a schematic diagram of an example networked or distributed computing environment. The distributed computing environment comprises computing objects 610, 612, etc., and computing objects or devices 620, 622, 624, 626, 628, etc., which may include programs, methods, data stores, programmable logic, etc. as represented by example applications 630, 632, 634, 636, 638. It can be appreciated that computing objects 610, 612, etc. and computing objects or devices 620, 622, 624, 626, 628, etc. may comprise different devices, such as personal digital assistants (PDAs), audio/video devices, mobile phones, MP3 players, personal computers, laptops, etc.

Each computing object 610, 612, etc. and computing objects or devices 620, 622, 624, 626, 628, etc. can communicate with one or more other computing objects 610, 612, etc. and computing objects or devices 620, 622, 624, 626, 628, etc. by way of the communications network 640, either directly or indirectly. Even though illustrated as a single element in FIG. 6, communications network 640 may comprise other computing objects and computing devices that provide services to the system of FIG. 6, and/or may represent multiple interconnected networks, which are not shown. Each computing object 610, 612, etc. or computing object or device 620, 622, 624, 626, 628, etc. can also contain an application, such as applications 630, 632, 634, 636, 638, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 6, as a non-limiting example, computing objects or devices 620, 622, 624, 626, 628, etc. can be thought of as clients and computing objects 610, 612, etc. can be thought of as servers where computing objects 610, 612, etc., acting as servers provide data services, such as receiving data from client computing objects or devices 620, 622, 624, 626, 628, etc., storing of data, processing of data, transmitting data to client computing objects or devices 620, 622, 624, 626, 628, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 640 or bus is the Internet, for example, the computing objects 610, 612, etc. can be Web servers with which other computing objects or devices 620, 622, 624, 626, 628, etc. communicate via any of a number of known protocols, such as the hypertext transfer protocol (HTTP). Computing objects 610, 612, etc. acting as servers may also serve as clients, e.g., computing objects or devices 620, 622, 624, 626, 628, etc., as may be characteristic of a distributed computing environment.

### Example Operating Environment

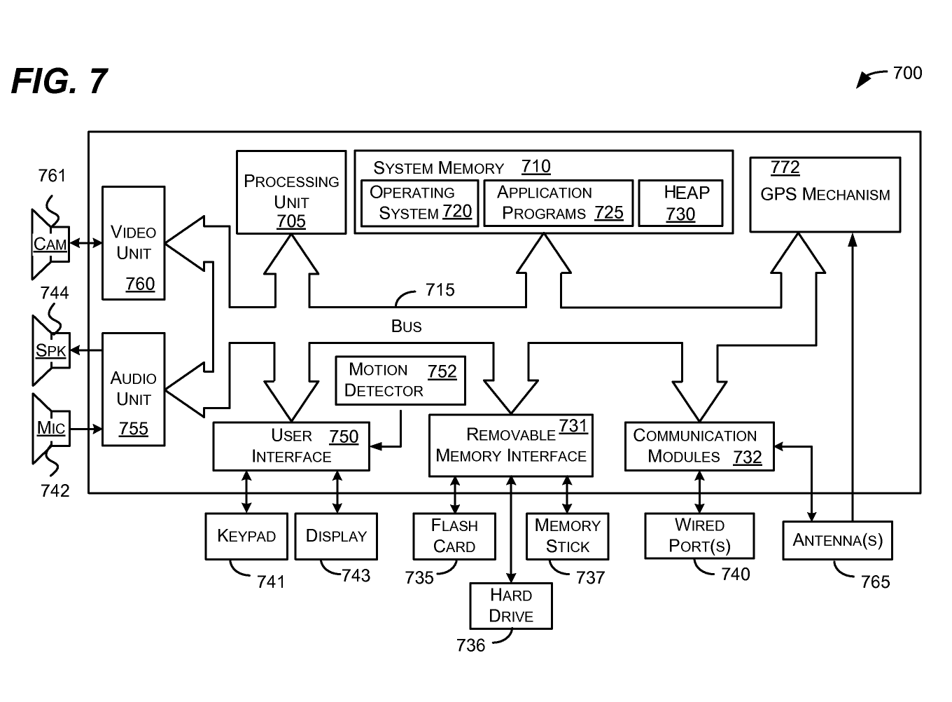

FIG. 7 illustrates an example of a suitable mobile device 700 on which aspects of the subject matter described herein may be implemented. The mobile device 700 is only one example of a device and is not intended to suggest any limitation as to the scope of use or functionality of aspects of the subject matter described herein. Neither should the mobile device 700 be interpreted as having any dependency or requirement relating to any one or combination of components illustrated in the example mobile device 700.

With reference to FIG. 7, an example device for implementing aspects of the subject matter described herein includes a mobile device 700. In some embodiments, the mobile device 700 comprises a cell phone, a handheld device that allows voice communications with others, some other voice communications device, or the like. In these embodiments, the mobile device 700 may be equipped with a camera for taking pictures, although this may not be required in other embodiments. In other embodiments, the mobile device 700 may comprise a personal digital assistant (PDA), hand-held gaming device, notebook computer, printer, appliance including a set-top, media center, or other appliance, other mobile devices, or the like. In yet other embodiments, the mobile device 700 may comprise devices that are generally considered non-mobile such as personal computers, servers, or the like.

Components of the mobile device 700 may include, but are not limited to, a processing unit 705, system memory 710, and a bus 715 that couples various system components including the system memory 710 to the processing unit 705. The bus 715 may include any of several types of bus structures including a memory bus, memory controller, a peripheral bus, and a local bus using any of a variety of bus architectures, and the like. The bus 715 allows data to be transmitted between various components of the mobile device 700.

The mobile device 700 may include a variety of computer-readable media. Computer-readable media can be any available media that can be accessed by the mobile device 700 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 700.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, Wi-Fi, WiMAX, and other wireless media. Combinations of any of the above should also be included within the scope of computer-readable media.

The system memory 710 includes computer storage media in the form of volatile and/or nonvolatile memory and may include read only memory (ROM) and random access memory (RAM). On a mobile device such as a cell phone, operating system code 720 is sometimes included in ROM although, in other embodiments, this is not required. Similarly, application programs 725 are often placed in RAM although again, in other embodiments, application programs may be placed in ROM or in other computer-readable memory. The heap 730 provides memory for state associated with the operating system 720 and the application programs 725. For example, the operating system 720 and application programs 725 may store variables and data structures in the heap 730 during their operations.

The mobile device 700 may also include other removable/non-removable, volatile/nonvolatile memory. By way of example, FIG. 7 illustrates a flash card 735, a hard disk drive 736, and a memory stick 737. The hard disk drive 736 may be miniaturized to fit in a memory slot, for example. The mobile device 700 may interface with these types of non-volatile removable memory via a removable memory interface 731, or may be connected via a universal serial bus (USB), IEEE 7394, one or more of the wired port(s) 740, or antenna(s) 765. In these embodiments, the removable memory devices 735-437 may interface with the mobile device via the communications module(s) 732. In some embodiments, not all of these types of memory may be included on a single mobile device. In other embodiments, one or more of these and other types of removable memory may be included on a single mobile device.

In some embodiments, the hard disk drive 736 may be connected in such a way as to be more permanently attached to the mobile device 700. For example, the hard disk drive 736 may be connected to an interface such as parallel advanced technology attachment (PATA), serial advanced technology attachment (SATA) or otherwise, which may be connected to the bus 715. In such embodiments, removing the hard drive may involve removing a cover of the mobile device 700 and removing screws or other fasteners that connect the hard drive 736 to support structures within the mobile device 700.

The removable memory devices 735-737 and their associated computer storage media, discussed above and illustrated in FIG. 7, provide storage of computer-readable instructions, program modules, data structures, and other data for the mobile device 700. For example, the removable memory device or devices 735-737 may store images taken by the mobile device 700, voice recordings, contact information, programs, data for the programs and so forth.

A user may enter commands and information into the mobile device 700 through input devices such as a key pad 741 and the microphone 742. In some embodiments, the display 743 may be touch-sensitive screen and may allow a user to enter commands and information thereon. The key pad 741 and display 743 may be connected to the processing unit 705 through a user input interface 750 that is coupled to the bus 715, but may also be connected by other interface and bus structures, such as the communications module(s) 732 and wired port(s) 740. Motion detection 752 can be used to determine gestures made with the device 700.

A user may communicate with other users via speaking into the microphone 742 and via text messages that are entered on the key pad 741 or a touch sensitive display 743, for example. The audio unit 755 may provide electrical signals to drive the speaker 744 as well as receive and digitize audio signals received from the microphone 742.

The mobile device 700 may include a video unit 760 that provides signals to drive a camera 761. The video unit 760 may also receive images obtained by the camera 761 and provide these images to the processing unit 705 and/or memory included on the mobile device 700. The images obtained by the camera 761 may comprise video, one or more images that do not form a video, or some combination thereof.

The communication module(s) 732 may provide signals to and receive signals from one or more antenna(s) 765. One of the antenna(s) 765 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 772. In turn, the GPS mechanism 772 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 700 may connect to one or more remote devices. The remote devices may include a personal computer, a server, a router, a network PC, a cell phone, a media playback device, a peer device or other common network node, and typically includes many or all of the elements described above relative to the mobile device 700.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server may be used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A method performed at least in part on at least one processor comprising:
maintaining context information based upon sensor data received from mobile device clients corresponding to workers;
receiving a task set comprising one or more tasks for which a worker set comprising one or more workers is needed to perform;
accessing task metadata associated with the task, the task metadata specifying one or more context-related criteria;
accessing the context information to select one or more workers for the worker set based at least in part upon matching the context information of each selected worker with the one or more context-related criteria of the task metadata; and
assigning the task set to the worker set.

2. The method of claim 1 further comprising, ranking a plurality of workers that each have associated context information that meets the context-related criteria based at least in part upon the associated context information for each worker.

3. The method of claim 1 further comprising, accessing static worker data to select the one or more workers for the worker set based at least in part upon matching the static worker data with one or more worker-related criteria specified in the task metadata.

4. The method of claim 1 further comprising, ranking a plurality of workers that each have associated context information that meets the context-related criteria based at least in part upon the static worker data for each worker.

5. The method of claim 1 further comprising, managing completion of the task set by the worker set.

6. The method of claim 1 wherein assigning the task set to the worker set comprises sending each worker of the worker set the task set to complete as an offer, and receiving an acceptance from each worker of the worker set.

7. The method of claim 1 wherein assigning the task set to the worker set comprises sending a worker of the worker set a notification based upon a ranking score or confidence score, or both, associated with the worker.

8. The method of claim 1 wherein assigning the task set to the worker set comprises sending a worker of the worker set an offer based upon a request for a task made by the worker.

9. The method of claim 1 wherein assigning the task set to the worker set comprises providing each client mobile device corresponding to worker of the worker set with at least one task including a script for hosting in a client mobile device browser.

10. The method of claim 9 further comprising receiving a script in text form and compiling the script in text form into html/JavaScript.

11. The method of claim 1 wherein maintaining the context information comprises receiving the context information from a sensing process executing on at least one client mobile device.

12. The method of claim 1 wherein maintaining the context information comprises receiving the context information from a sensing process executing at least occasionally as a background process on at least one client mobile device.

13. A system comprising, a mobile crowd sourcing service configured to assign tasks to mobile workers, including a task server configured to receive tasks from a task issuer, and a task broker configured to match received tasks with selected workers corresponding to mobile device clients, including for at least one task, to match one or more workers based upon per-worker data and one or more worker-related task criteria associated with the task, and based upon per-worker context information and one or more context-related task criteria associated with the task.

14. The system of claim 13 wherein at least some of the tasks are written as a cross-platform task.

15. The system of claim 13 wherein the per-worker data comprises at least one of: demographic information, personal information, statistical information, reputation information or user-preference information.

16. The system of claim 13 wherein the per-context information comprises at least one of: location data, trajectory data, network connection state data, motion data or current audio state data.

17. The system of claim 13 wherein the per-context information comprises activity-related data determined from at least one of: motion data, device interaction data or image data.

18. The system of claim 13 wherein the task is provided to the worker as an application to run on a mobile device of the user, and wherein the mobile device of the worker is configured to collect at least some data corresponding to performance of the task via a sensor of the mobile device.

19. One or more computer-readable storage media or logic having computer-executable instructions, which when executed perform steps, comprising: providing an application for executing on a mobile device, the application configured to execute a crowdsourcing task selected for a user of the mobile device based at least in part upon context information sensed at the mobile device, and in which the application is configured use to at least one sensor of the mobile device to automatically perform at least part of the task.

20. The one or more computer-readable storage media of claim 19 wherein the application executes at least one task written as a cross-platform task.
